(19) United States
(12) Patent Application Publication
(10) Pub. No.: US 2016/0014549 A1
(43) Pub. Date: Jan. 14, 2016

(54) Dual Mode RF System

(71) Applicant: MoJo Labs, Inc., Longmont, CO (US)

(72) Inventor: Morgan Jones, Longmont, CO (US)

(21) Appl. No.: 14/642,418

(22) Filed: Mar. 9, 2015

Related U.S. Application Data
(60) Provisional application No. 61/949,839, filed on Mar. 7, 2014.

(51) Int. Cl. H04W 4/00; H04W 24/02

(52) U.S. Cl. CPC H04W 4/008; H04W 24/02

(57) ABSTRACT

Methods and/or systems are disclosed for transmitting data using a Bluetooth protocol and a Bluetooth-like protocol. The Bluetooth-like protocol, for example, may have a data rate that is a fraction (e.g., a whole fraction) of the data rate of the Bluetooth protocol. Methods and/or systems may also include techniques for switching between the Bluetooth protocol and the Bluetooth-like protocol. Methods and/or systems may also include determining whether the communication is using the Bluetooth protocol or the Bluetooth-like protocol.

### SUMMARY

Embodiments of the invention include a low cost Bluetooth Low Energy (Bluetooth) Transceiver to both enable the “normal” Bluetooth connection to smart phones, but as well as communicating to an Internet connected gateway using a similar, but different protocol.

Bluetooth may only useful for short range communication—the protocol is designed for 1 MBPS transmission over the air, and this limits its range to about 25 meters.

However the same RF transceiver that can be used for Bluetooth can also be used at different over-the-air data rates, and reducing the data rate in this type of RF transceiver increases the transmission range. So, employing a dual-mode communication strategy enables both “normal” Bluetooth RF communication to smart phones as well as constantly Internet connected gateway communication.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE DRAWINGS

FIG. 1 shows a smart phone in wireless communication with a plurality of Bluetooth enabled devices according to some embodiments described within this document.

FIG. 2 shows a plurality of Bluetooth enabled devices wirelessly in communication with an Internet gateway according to some embodiments described within this document.

FIG. 3A illustrates the conversion of an aliased data stream received from an antenna into a non-aliased data stream according to some embodiments described within this document.

FIG. 3B illustrates conversion of a non-aliased data stream into an aliased data stream prior to transmission according to some embodiments described within this document.

FIG. 4 illustrates the use of two correlators to determine whether a Bluetooth or a Bluetooth-like protocol is used in a transmission according to some embodiments described within this document.

FIG. 5 illustrates a flowchart of a method for a dual mode operation according to some embodiments described within this document.

FIG. 6 illustrates a mesh network utilizing Bluetooth and Bluetooth-like protocols according to some embodiments described within this document.

FIG. 7 illustrates a TDMA implementation of a Bluetooth and a Bluetooth-like protocol according to some embodiments described within this document.

FIG. 8 illustrates Bluetooth-like mesh according to some embodiments described within this document.

FIG. 9 illustrates a computational system according to some embodiments described within this document.

### DETAILED DESCRIPTION

Bluetooth is a wireless communication protocol for exchanging data over short distances (using short-wavelength radio waves in the ISM band from 2.4 to 2.485 GHz) from fixed and mobile devices, and building personal area networks (PANs).

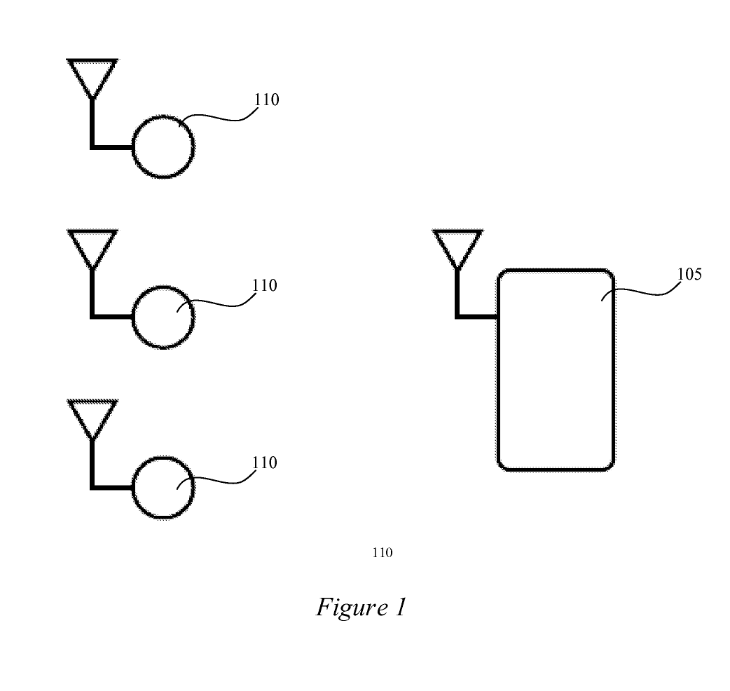

FIG. 1 shows a smart phone 105 in wireless communication with a plurality of Bluetooth enabled devices 110 according to some embodiments described within this document. The Bluetooth enabled devices 110 and the smart phone 105, for example, may communicate using a Bluetooth protocol and/or a Bluetooth-like protocol.

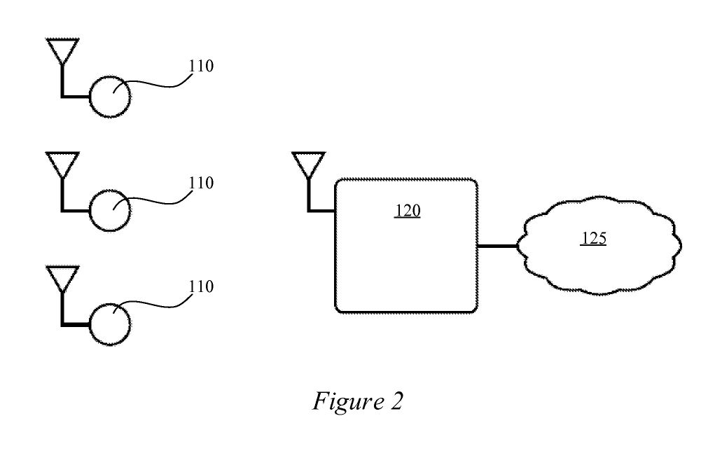

FIG. 2 shows a plurality of Bluetooth enabled devices 110 wirelessly in communication with an Internet gateway 120 according to some embodiments described within this document. The Bluetooth enabled devices 110 and the Internet gateway 120, for example, may communicate using a Bluetooth protocol and/or a Bluetooth-like protocol.

For example, a low cost Bluetooth Low Energy (Bluetooth) transceiver can be used with the Bluetooth enabled devices 110 to both enable the “normal” Bluetooth connection to the smart phone 105 (e.g., FIG. 1), as well as communicating to an Internet gateway 120 (e.g., FIG. 2) using a similar, but possibly different communication protocol.

Bluetooth communicates at 1 MBPS over the air, and has a fairly short range of about 25 meters. It is intended for local connections of devices to smart phones and so longer range is not a requirement. The short range of the Bluetooth communication protocol can make Bluetooth a poor choice for Internet of Things (IOT) devices that need to be connected to the Internet constantly. Often times, the short range can be a problem. For example, long distances may need to be covered to communicate back to an Internet gateway. As another example, an IOT protocol would want to use a routing architecture such as a mesh.

In some embodiments, a single Bluetooth transceiver can operate in a Bluetooth mode and a Bluetooth-like mode. The Bluetooth mode, for example, may include communication using the Bluetooth protocol at a data rate of about 1 Mbs. The Bluetooth-like mode, for example, may include communication using a Bluetooth protocol but at a data rate of about 250 kbs. At this lower data rate, the range may be increased such as, for example, up to about 450 feet. In some embodiments, this range, for example, may be sufficient for IOT purposes. In some embodiments, this distance may enable constantly-connected IOT devices to communicate with an Internet hub.

Dual use of Bluetooth and an alternate protocol running at 250 kbps is particularly attractive. For discussion sake, this 2nd protocol running at 250 kbps is referred to as Bluetooth-like. An IOT device that can both run Bluetooth and Bluetooth-like can then be constantly connected to the Internet, and also support direct connection to smart phones.

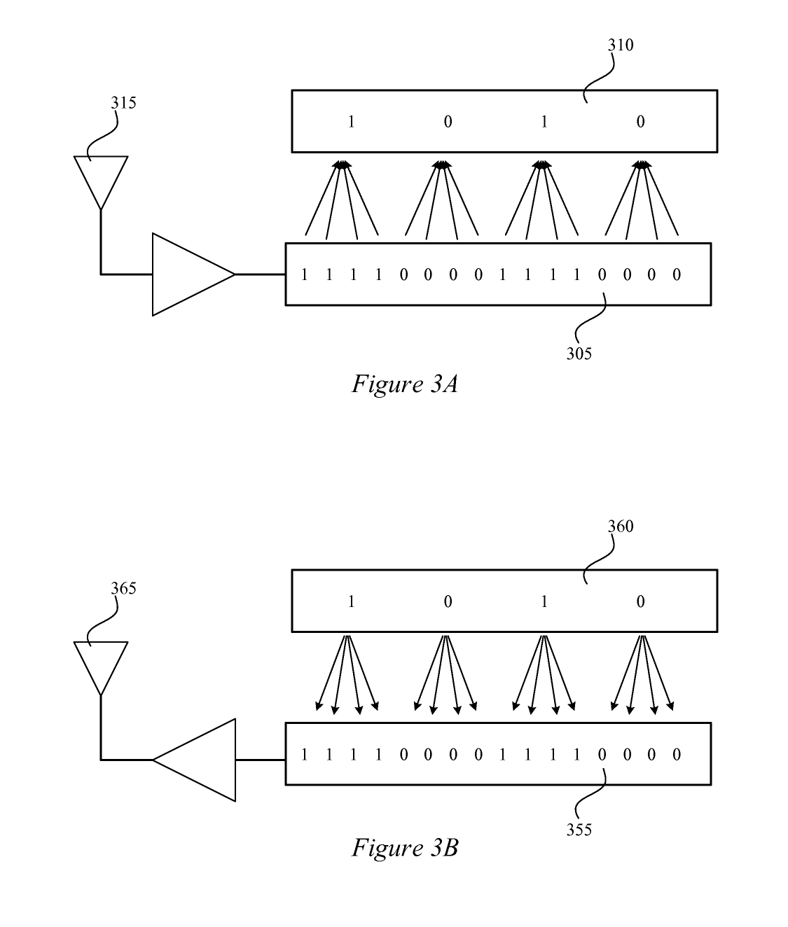

A Bluetooth-like protocol may include a communication protocol that is similar to Bluetooth but aliases the data sot that it is transmitted at a lower data rate. Since the Bluetooth protocol dictates the data rate, this can be accomplished, for example, by aliasing bits as shown in FIG. 3A and FIG. 3B. In FIG. 3A, an aliased data stream 305 is received via antenna 315. The aliased data stream 305 can be converted into a non-aliased data stream 310. As shown, every four asserted bits in the aliased data stream 305 corresponds to a single asserted bit in the non-aliased data stream 310, and every four non-asserted bits in the aliased data stream 305 corresponds to a single non-asserted bit in the non-aliased data stream 310. While four bits are used in this example, two, three or more bits may be used. In some embodiments, aliasing the data stream may slow down the data rate.

FIG. 3B shows aliasing of a data stream on the transmitter side. The non-aliased data stream 360, for example, may be received at a transceiver (e.g., from another component) and converted to the aliased data stream 355 prior to transmission using the Bluetooth protocol. After aliasing, the aliased data stream 355 may be transmitted via antenna 365. In this way, for example, the non-aliased data stream 360 can be communicated through a Bluetooth channel operating at a high data rate, which may allow the data to be transmitted longer distances.

In some embodiments, Bluetooth devices may send out periodic advertisement packets at 1 MBPS on one of three dedicated advertising channels. A problem of a device wishing to both communicate with the Bluetooth protocol and the Bluetooth-like protocol simultaneously is that it is not possible to listen at both data rates at the same time. Embodiments described in this document include a method of simultaneous operation of the Bluetooth protocol and the Bluetooth-like protocol. In some embodiments, the Bluetooth-like protocol may operate at a data rate that is a fraction of the data rate of the Bluetooth protocol such as, for example, a 250 kpbs data rate for the Bluetooth-like protocol may be exactly ¼ of a 1 MBPS data rate of the Bluetooth protocol. In some embodiments, it may be possible to receive packets at two different data rates with the assumption that the Bluetooth-like data is transmitted at a data rate that is a known fraction of the Bluetooth data rate.

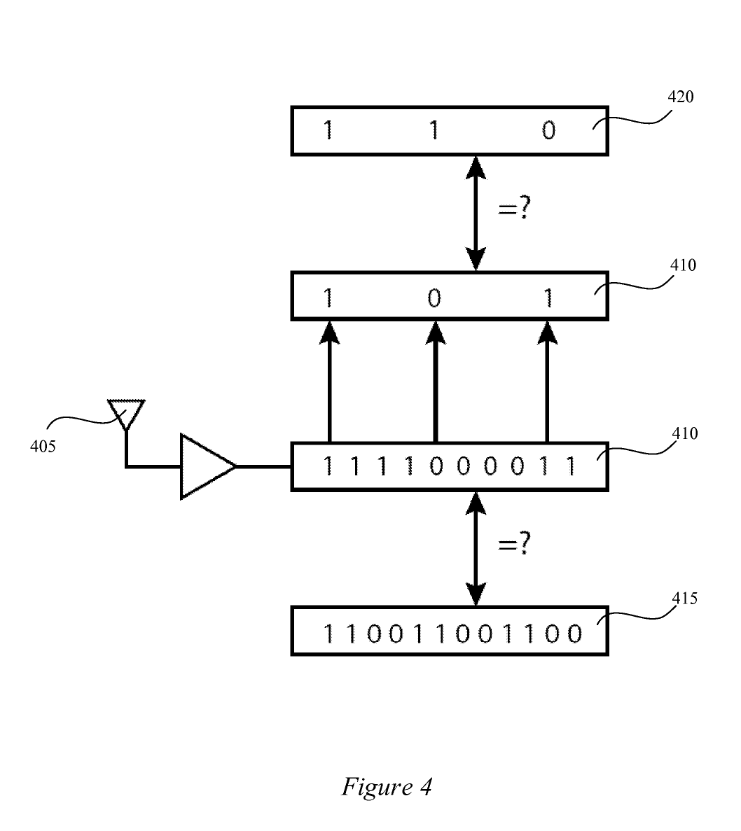

For example, if a packet includes an asserted bit at 250 kbps, this asserted data bit will be sampled as four contiguous asserted bits at 1 MBPS. Similarly, a non-asserted bit at 250 kbps may be sampled as four contiguous non-asserted bits at 1 MBPS. By exploiting this aliasing, a receiving device could listen for both data rates simultaneously as shown in FIG. 4.

The problem then moves up the receive chain from the physical layer to the link and/or packet layers to handle both protocols at the same time. Bluetooth has the following packet structure:

FIG. 2.1: Link Layer packet format

| | | | |
|---|---|---|---|
| LSB | | | MSB |
| Preamble | Access Address | PDU | CRC |
| (1 octet) | (4 octets) | (2 to 39 octets) | (3 octets) |

It could be possible to receive a very short packet that was sent at 250 kbps with a standard Bluetooth receiver at 1 MPBS. But, to achieve this, a non-standard preamble of 00001111 or 1111000 would be sent, and then the access address would be encoded at 250 kbps so that it has sequences of 0000's and 1111's. This would achieve packet reception by existing Bluetooth transceivers. However, such a packet would have only 39/4 bytes of data in it.

It would be very practical to design a dual-mode transceiver chip that would simultaneously receive Bluetooth protocol data and Bluetooth-like protocol data by listening simultaneously to the two different data rates of 1 MBPS and 250 kbps. The radio portion of this chip may be similar to existing transceivers, but it would feed two separate paths of correlators and receive data bytes as shown in FIG. 4. One correlator may analyze the data stream 410 to determine whether it matches the Bluetooth preamble 415 at the Bluetooth data rate. Another correlator may analyze the de-aliased data stream 410 that corresponds with data stream 410 after de-aliasing. The de-aliased data stream 410 may be compared with the Bluetooth-like preamble 420 at the Bluetooth-like data rate.

Alternatively, without separate correlators, a very usable system could be built with only one receiver chain, but with a longer data field so that usable packet sizes would be achievable at 250 kbps.

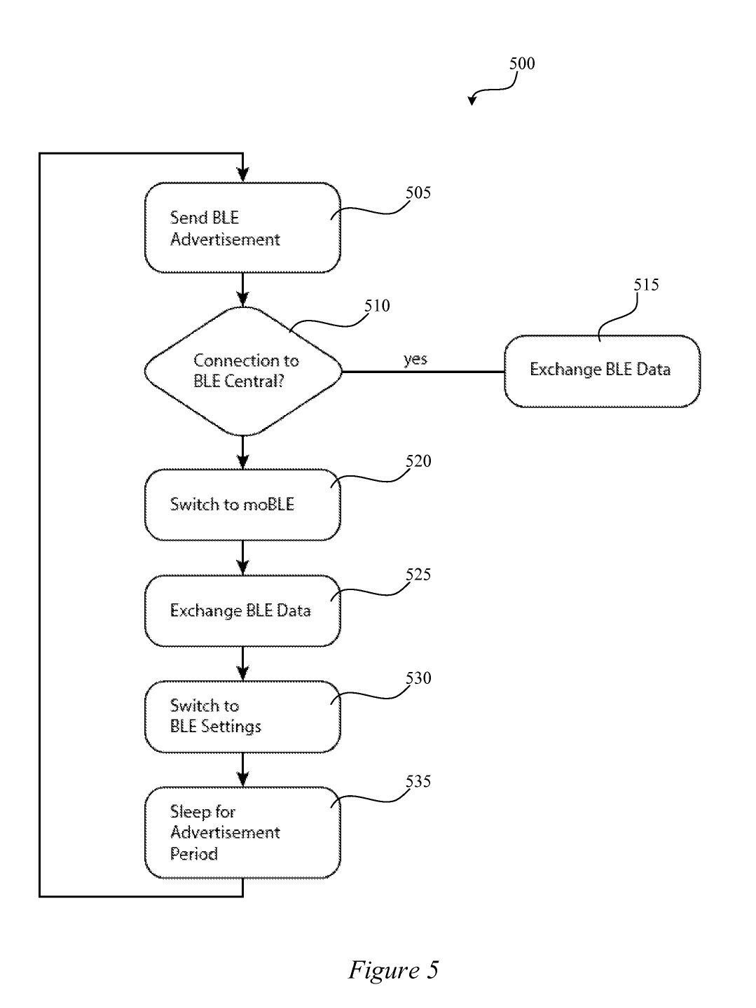

FIG. 5 illustrates a flowchart of a method 500 for a dual mode operation according to some embodiments described within this document. In some embodiments, two protocols (e.g., Bluetooth mode and Bluetooth-like mode) may be used with one protocol in use at a given moment in time. Method 500 may be executed by any device with a Bluetooth enabled transceiver such as, for example, a smartphone, a tablet, a computer, a digital device, a wearable device, etc.

At block 505 a Bluetooth advertisement may be sent from a device. The Bluetooth advertisement may be any type of Bluetooth advertisement at any data rate such as, for example, the standard Bluetooth data rate (e.g., 1 Mbps).

At block 510 it can be determined whether the device has made a Bluetooth connection. If a Bluetooth connection has been made, then method 500 may proceed to block 515 where data may be exchanged at block 515. If no Bluetooth connection has been made at block 510, the method 500 may proceed to block 520 where the device (e.g., the transceiver) may change to the Bluetooth-like mode. At block 525, data may be exchanged using the Bluetooth-like protocol.

At block 530 the device may change to Bluetooth mode. At block 535 the device may sleep for the predetermined Bluetooth advertisement period.

An example, top-level simplified view of a Bluetooth communication process may include:
Loop:
   Send Bluetooth Advertisement
   Connection to Bluetooth central? (ie, smart phone) Exchange Bluetooth data until connection done
   Sleep for advertisement period

The device sends advertisement packets until a connection is made to another Bluetooth enabled device. When a connection happens, the device stops advertising and exchanges data with the central Bluetooth that initiates the connection. After which the device sleeps for the predetermined Bluetooth advertisement period.

An example top-level simplified view of the one-at-a-time-dual-mode process may include:
Loop Forever:
   Send Bluetooth Advertisement
   Connection to Bluetooth central? (ie, smart phone) Exchange Bluetooth data until connection done
   Switch to Bluetooth-like settings (250 kbps)
   Send and receive Bluetooth-like packets
   Switch to Bluetooth settings (1 MBPS)
   Sleep for advertisement period

The device may switch back and forth between the two data rates to handle data transmitted with the Bluetooth protocol and/or at the Bluetooth data rate and data transmitted with the Bluetooth-like protocol and/or at the Bluetooth-like data rate. When a Bluetooth connection is made, data may be exchanged using the standard Bluetooth protocol such as, for example, no Bluetooth advertisements or Bluetooth-like traffic may be transmitted or received until the Bluetooth connection terminates.

The interval of switching back and forth can be very quick. For example, the switching may be inside the normal Bluetooth advertising interval. Bluetooth advertisement periods can range, for example, from 20 ms to 10 s. If a Bluetooth advertisement period of 250 ms or 500 ms were chosen, the Bluetooth-like traffic could easily fit in between the advertisement interval. In some embodiments, a user may not know that their device is communicating with a Bluetooth protocol or a Bluetooth-like protocol. In some embodiments, the interval of switching may be so quick that communication of Bluetooth-like information can happen even during a Bluetooth connection to a smart phone. Since Bluetooth may be a rigorously time scheduled protocol, many open time intervals may exist during a Bluetooth connection that may be used for alternative means, such as Bluetooth-like communication.

The combination of a Bluetooth protocol and a Bluetooth-like protocol (in any of its forms described in this document) enables the identification of specific devices by using the difference in range of the two protocols. Bluetooth, for example, may be well suited to short range communication of up to 25-50 m. Thus, Bluetooth protocols may be used to discern which light or which electrical outlet is in front of you is convenient. Bluetooth-like protocols may then provide the longer range always-connected-to-the-Internet communication.

A mode of the Bluetooth-like protocol may be used to vary the transmit power and/or gate received packets by looking at RSSI to determine proximity. For example, to find the specific device or devices nearby a device may execute the following:
Loop:
   Set tx level to lowest level
   Send Bluetooth-like broadcast discovery packet at tx level
   Response received? If so, device found
   If not, increment tx level

Alternatively or additionally, the received strength (RSSI) of a packet could be used to detect proximity. For this method:
Send out Bluetooth-like broadcast discovery packet
Loop over responses:
   minimum found? If so, device found

In some embodiments, RF transmission strengths can be misleading, and so other, more concrete methods of proximity detection may be used such as, for example:
Pressing a button on the end unit you wish to discover
Having an optical LED from the end device encode the device identifier over the light itself be received at the smart phone.
Bumping the smart phone into the end device, and having vibration sensors in the end device itself detecting the vibration of the smart phone being bumped.

In some embodiments, a mesh of Bluetooth-like devices that use the Bluetooth-like devices to route packets to the internet via a gateway, a smart phone can be used as an intermittent gateway when it is available. When this is the case, re-routing Bluetooth-like messages to the smart phone can result is lower latency of message delivery to the Internet as well as better battery life for routing Bluetooth-like devices. This can happen in the case where the smart phone shortens the routing path for Bluetooth-like Internet destined messages.

In some embodiments, a Bluetooth-like network of devices can be used to organize and/or nominate a device to issue Bluetooth advertisements. In this way, not all devices would advertise Bluetooth packets, but some small percentage of the device.

This negotiation and nomination of Bluetooth advertisers could be accomplished in many ways. One method, for example, would be to use Bluetooth advertisement packets and apply a RSSI threshold to prevent an individual device from issuing a Bluetooth advertisement. Algorithmically, each device in the network could, for example, perform the following:
Set timer for Periodic Bluetooth advertisement
On Bluetooth advertisement:
   Send Bluetooth Advertisement
On Reception of Bluetooth Advertisement:
   If RSSI is greater than a threshold, reset the Bluetooth advertisement timer

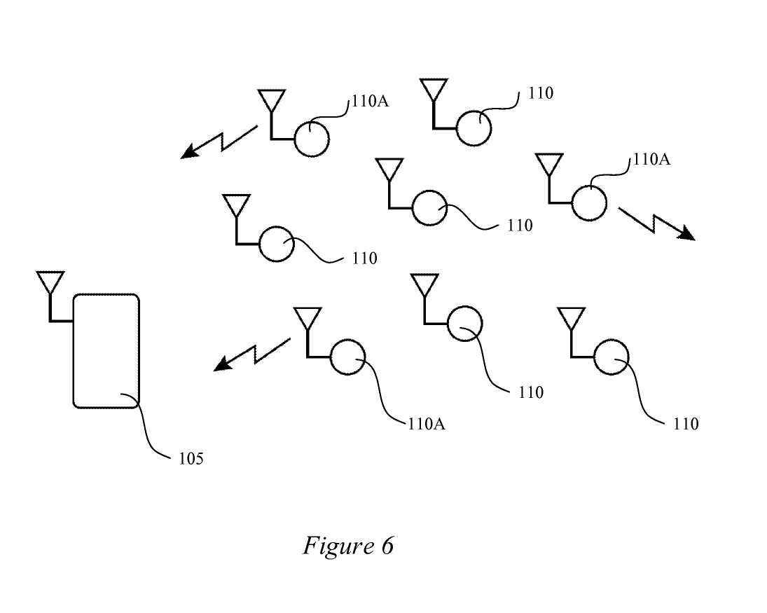

FIG. 6 illustrates a mesh network utilizing Bluetooth and Bluetooth-like protocols according to some embodiments described within this document. The smartphone 105, for example, can be in communication with a plurality of devices 110A using the Bluetooth protocol. The smartphone 105 may also be in communication with a plurality of devices 110 via one or more of devices 110A. For example, the plurality of devices 110 may communicate with the plurality of devices 110A using the Bluetooth-like protocol. Thus, the plurality of devices 110 may communicate with the smart phone 105 through the one or more devices 110A. In some embodiments, for example, the plurality of devices 110A and/or the plurality of devices 110 (e.g., the mesh) may distribute Bluetooth advertisements relatively evenly across its physical layout. In some embodiments, the smart phone 105 may receive a Bluetooth advertisement from devices in the network no matter where it was located, but may not be overwhelmed with advertisements.

If a smart phone initiates a Bluetooth connection to the Bluetooth-like mesh network, adjacent Bluetooth-like nodes can then become “helper” nodes to the node that is dedicated to communicating to the smart phone over Bluetooth. Ie, this node is then concentrating on the Bluetooth connection and so then cannot talk Bluetooth-like. The helper nodes could translate between Bluetooth-like and Bluetooth so that the dedicated Bluetooth node can maintain its Bluetooth-like connection to the mesh. And, as discussed above, the Bluetooth dedicated node can become a new temporary Internet gateway for the mesh.

The helper nodes translating from Bluetooth-like and Bluetooth would also reduce latency of packet communication from the smart phone to other nodes close by. For example, if a command to turn a light on and off were sent from the phone through its Internet connection, through the Bluetooth-like Internet gateway to a light close to the smart phone, a delay of a few seconds could result. However, if the command were sent through the local Bluetooth connection and then translated to Bluetooth-like to reach the local light, it would happen potentially in milliseconds.

The dual nature of Bluetooth-like and Bluetooth protocols may complement each other. The Bluetooth-like protocol, for example, may be good at always-on, Internet connected operation. The Bluetooth protocol, for example, may be good at a smart phone interacting directly with one end device that a person is close to.

The Bluetooth-like mesh could be used to determine the position of a smart phone in the local space. By knowing what Bluetooth-like node is closest to the smart phone by detecting the phone with Bluetooth advertisements or creating a Bluetooth communication with the phone, the Bluetooth-like mesh can then determine which node is closest to the smart phone and use that information intelligently. For example, advertisements could be delivered to the phone via the Bluetooth-like mesh. Or, local lights in proximity to the smart phone could be turned on, and then later turned off when the person with the smart phone leaves to save energy.

Alternatively or additionally, in some embodiments, Bluetooth-like protocols can be used to create a network graph of the mesh. Ie, nodes in the mesh can discover their neighbors, and so a proximity graph can be created from that information. In this way, devices can self-position in the network, and this information can be used to accomplish the benefits above.

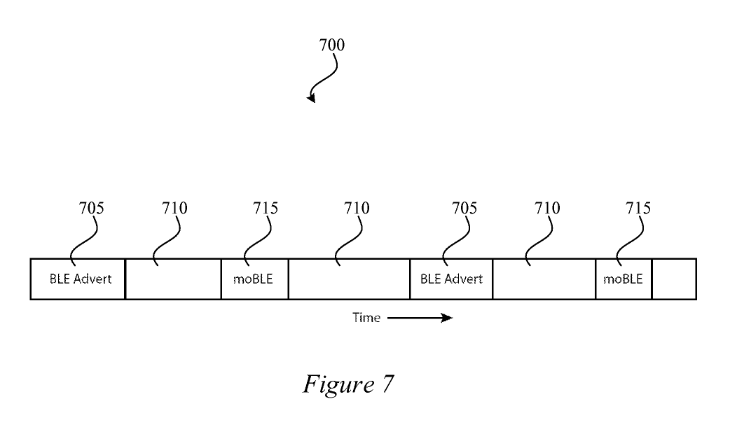

In some embodiments, the Bluetooth protocol, for example, may use smart timing and/or scheduling of packet communication to enable end devices to be completely off for periods of time to enable significant battery savings as shown in FIG. 7. This may result, for example, in predicable and/or bursty communication. A TDMA signal 700, for example, may include a Bluetooth advertisement period 705 followed by a Bluetooth communication period 710. The TDMA signal 700, for example, may also include a Bluetooth-like advertisement period 715 followed by Bluetooth-like communication period 720. The processes may then revert back to the Bluetooth advertisement period 705.

This communication timing, for example, can be used to enable simultaneous Time Division Multiple Access of Bluetooth and Bluetooth-like. In this example, the two protocols switch back and forth and/or may switch at a much finer-grained level such as, for example, down to individual packets.

Algorithmically, for example, a method may work as follows. The Bluetooth protocol stack could inform the Bluetooth-like protocol stack of time windows when there will be no Bluetooth communication.
on time window notification with start time and duration:
   switch to 250 kbps
   optionally change frequency or other RF parameters for Bluetooth-like
   send and receive Bluetooth-like packets
   reset data rate, frequency, etc. for Bluetooth

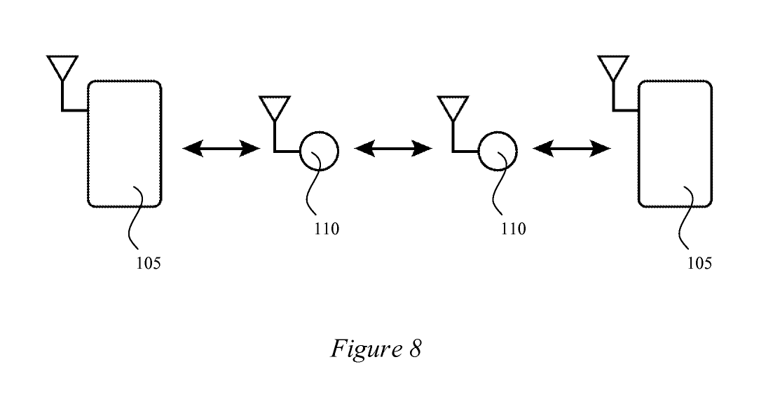

Any of the methods described in this document, for example, may be used to enable two smart phones to talk to one another, even though they would not necessarily be in Bluetooth range. As shown in FIG. 8, a Bluetooth-like mesh could be used to present a Bluetooth interface to each device (e.g., smart phone 105), and then route packets between two devices 110 using the Bluetooth-like protocol.

Some smart phones may always be connected to the Internet either from WiFi or over the cellular connection. In some embodiments, smart phones they can act as temporary, local gateways to Bluetooth-like nodes in the case where a Bluetooth-like device or devices are islanded, or don't have a Bluetooth-like Internet gateway.

For example, if a Bluetooth-like node in an energy saving light switch was installed in a home without a Bluetooth-like gateway, it would not have a means of connecting to the Internet in real time. But, when someone with a smart phone walked close to the Bluetooth-like node, it could initiate a Bluetooth connection to the smart phone, and then communicate information to the Internet. For example, it could save information on how much energy was saved over time, and then communicate that information via the smart phone to an Internet-based cloud service.

The communication could be two-way as well. New parameters for the end Bluetooth-like node's operation could be sent from the Internet to the end device and its operation changed as a result.

Embodiments described herein may include a number of benefits. These may include, for example,
Low cost RF transceiver.
Close-by connection to smart phones with long-distance connection to gateways.
Internet of things and smart phone connection gracefully.
Ease of control of specific devices with Bluetooth as well as Bluetooth-like always-connected Internet connectivity.

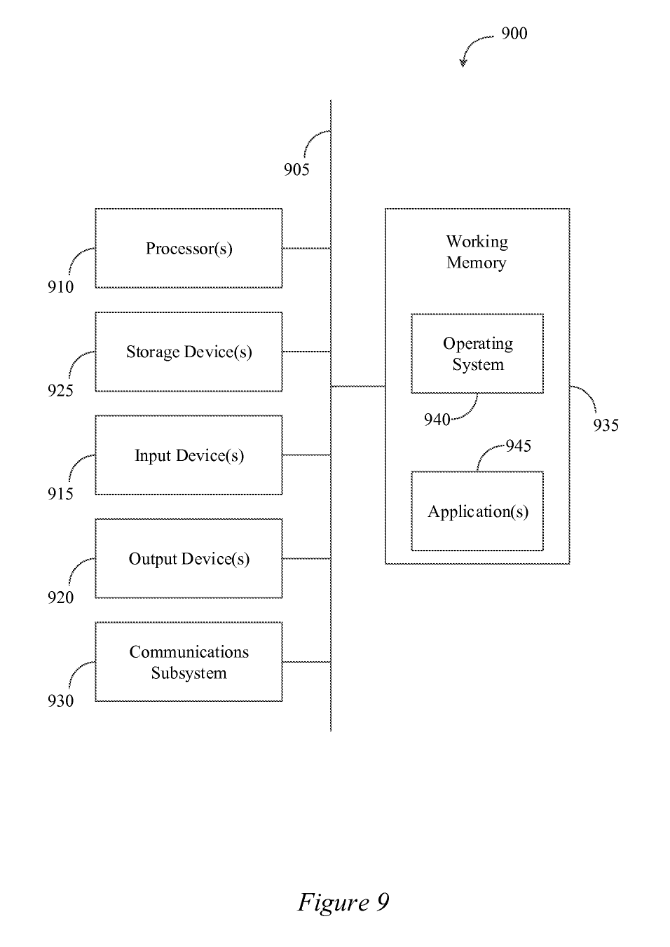

Embodiments described herein may use the computational system 900 900 (or processing unit), shown in FIG. 9, which can be used to perform any of the embodiments of the invention. For example, the computational system 900 can be used alone or in conjunction with other components. As another example, the computational system 900 can be used to perform any calculation, solve any equation, perform any identification, and/or make any determination described here. The computational system 900 includes hardware elements that can be electrically coupled via a bus (or may otherwise be in communication, as appropriate). The hardware elements can include one or more processors, including, without limitation, one or more general purpose processors and/or one or more special purpose processors (such as digital signal processing chips, graphics acceleration chips, and/or the like); one or more input devices, which can include, without limitation, a mouse, a keyboard, and/or the like; and one or more output devices, which can include, without limitation, a display device, a printer, and/or the like.

The computational system 900 may further include (and/or be in communication with) one or more storage devices, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 900 might also include a communications subsystem, which can include, without limitation, a modem, a network card (wireless or wired), an infrared communication device, a wireless communication device, and/or chipset (such as a Bluetooth device, an 802.6 device, a WiFi device, a WiMax device, cellular communication facilities, etc.), and/or the like. The communications subsystem may permit data to be exchanged with a network (such as the network described below, to name one example) and/or any other devices described herein. In many embodiments, the computational system 900 will further include a working memory, which can include a RAM or ROM device, as described above.

The computational system 900 also can include software elements, shown as being currently located within the working memory, including an operating system and/or other code, such as one or more application programs, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) described above.

In some cases, the storage medium might be incorporated within the computational system 900 or in communication with the computational system 900. In other embodiments, the storage medium might be separate from the computational system 900 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 900 and/or might take the form of source and/or installable code, which, upon compilation and/or installation on the computational system 900 (e.g., using any of a variety of generally available compilers, installation programs, compression/decompression utilities, etc.), then takes the form of executable code.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

That which is claimed:

1. A method comprising:
sending with a transceiver a Bluetooth protocol advertisement;
connecting with the transceiver with a Bluetooth enabled device;
exchanging, with the transceiver, data with the Bluetooth enabled device using the Bluetooth protocol;
sending with the transceiver a Bluetooth-like protocol advertisement;
connecting with the transceiver with a Bluetooth-like enabled device; and
exchanging, with the transceiver, data with the Bluetooth-like enabled device using the Bluetooth-like protocol.

2. The method according to claim 1, wherein the Bluetooth protocol transmits and receives data at 1 MBPS and the Bluetooth-like protocol transmits and receives data at 250 kbps or less.

3. The method according to claim 1, wherein the exchanging data with the Bluetooth-like enabled device using the Bluetooth-like protocol occurs over a longer range than the exchanging data with the Bluetooth enabled device using the Bluetooth protocol.

4. The method according to claim 1, wherein the Bluetooth-like protocol aliases data so the data is exchanged over a Bluetooth channel with an effective data rate that is lower than the data exchanged with the Bluetooth protocol.

5. A method comprising:
receiving a digital signal comprising a plurality of non-asserted bits and a plurality of asserted bits;
aliasing the non-asserted bits as a plurality of contiguous non-asserted bits;
aliasing the asserted bits as a plurality of contiguous asserted bits; and
transmitting an aliased signal that comprises the plurality of contiguous non-asserted bits and the plurality of contiguous asserted bits over a communication channel having a data rate at least twice the data rate of the aliased signal.

6. The method according to claim 5, wherein the communication channel has a data rate at least four times the data rate of the aliased signal.

7. The method according to claim 5, wherein the communication channel is a Bluetooth communication channel.

8. The method according to claim 5, wherein the data rate of the aliased signal is less than 250 kbs and the data rate of the communication channel is 1 Mbs.

9. A method comprising:
transmitting a Bluetooth advertisement according to a Bluetooth protocol;
transmitting data according to the Bluetooth protocol;
transmitting a Bluetooth-like advertisement according to a Bluetooth-like protocol, wherein the Bluetooth-like protocol has a data rate that is a fraction of the data rate of the Blue tooth protocol; and
transmitting data according to the Bluetooth-like protocol.
